(19) United States
(12) Patent Application Publication
(10) Pub. No.: US 2008/0225274 A1
(43) Pub. Date: Sep. 18, 2008

(54) Vibration detection device

(75) Inventors: Shoji Hirata, Kanagawa (JP); Kayoko Taniguchi, Kanagawa (JP); Akihiro Kuroda, Tokyo (JP); Kazutoshi Nomoto, Kanagawa (JP)

Correspondence Address: RADER FISHMAN & GRAUER PLLC, LION BUILDING, 1233 20TH STREET N.W., SUITE 501, WASHINGTON, DC, 20036, US

(73) Assignee: Sony Corporation, Tokyo (JP)

(21) Appl. No.: 12/068,397

(22) Filed: Feb. 6, 2008

(30) Foreign Application Priority Data
Feb. 16, 2007 (JP) 2007-036411

(51) Int. Cl. G01N 21/00

(52) U.S. Cl. 356/73

(57) ABSTRACT

A vibration detection device includes: a light source emitting a laser beam; an interferometer including a vibrating body and a reflecting body both capable of reflecting the laser beam, a polarizing beam splitter splitting a laser beam emitted from the light source into beams traveling along first and second optical paths, a first ¼ wave plate arranged between the polarizing beam splitter and the vibrating body in the first optical path, and a second ¼ wave plate arranged between the polarizing beam splitter and the reflecting body in the second optical path, the interferometer causing interference between a reflected beam reflected by the vibrating body and a reference beam reflected by the reflecting body to form a interference pattern; and a detection means quantizing the vibration of the vibrating body on the basis of the formed interference pattern to detect the vibration.

### CROSS REFERENCES TO RELATED APPLICATIONS

The present invention contains subject matter related to Japanese Patent Application JP 2007-036411 filed in the Japanese Patent Office on Feb. 16, 2007, the entire contents of which being incorporated herein by reference.

### BACKGROUND OF THE INVENTION

1. Field of the Invention

The present invention relates to a vibration detection device optically detecting the displacement of a vibrating body.

2. Description of the Related Art

In recent years, recording systems and the like using a SACD (Super Audio Compact Disc) or 24-bit/96 kHz sampling have been used, and a trend toward higher sound quality is becoming mainstream. In such a trend, analog microphone apparatuses in related arts have a limit to record sound specifically with a high frequency of 20 kHz or over, so in the case where contents are recorded by making use of reproduction of high- frequency sound as a characteristic of the above-described recording systems, the analog microphone apparatuses are a bottleneck.

Moreover, the dynamic range of the analog microphone apparatuses does not reach 144 dB which is allowed in 24-bit recording as a characteristic of the above-described recording systems, so the analog microphone apparatuses do not sufficiently exploit a wide dynamic range.

Further, at a recording site, in analog microphone apparatuses in related arts, noises are increased due to a long analog cable run length, or it is necessary to supply phantom power from a mixing console to a condenser microphone, so it causes an impediment to total digitization in a recording/producing system.

Therefore, in recent years, some digital microphone apparatuses have been proposed (for example, refer to Japanese Unexamined Patent Application Publication Nos. H10-308998 and H11-178099). Moreover, as a technique related to them, for example, a displacement detecting device disclosed in Japanese Unexamined Patent Application Publication No. 2003-322552 has been proposed.

### SUMMARY OF THE INVENTION

In Japanese Unexamined Patent Application Publication No. H10-308998, a laser source and a Mach-Zehnder interferometer are used to detect vibration of a vibrating plate, thereby digital audio signals are outputted.

On the other hand, in Japanese Unexamined Patent Application Publication No. H11-178099, a ΔΣ (delta sigma) converter including a laser source and a vibrating plate is configured. Therefore, it is considered that by the function of the ΔΣ converter, 1-bit digital audio signals can be obtained with a simple configuration, and noises of audio signals in an audible band can be reduced by a noise shaving effect.

However, digital microphone apparatuses (more commonly, vibration detection devices) using a laser beam in related arts which include the digital microphone apparatuses disclosed in Japanese Unexamined Patent Application Publication Nos. H10-308998 and H11-178099 have complicated configuration, so it is difficult to reduce the sizes of the apparatuses, and there is room for improvement.

In view of the foregoing, it is desirable to provide a vibration detection device optically performing digital vibration detection and being capable of reducing its size.

According to an embodiment of the invention, there is provided a vibration detection device including: a light source emitting a laser beam; an interferometer; and a detection means. The interferometer includes a vibrating body and a reflecting body both capable of reflecting the laser beam, a polarizing beam splitter splitting a laser beam emitted from the light source into beams traveling along first and second optical paths, a first ¼ wave plate arranged between the polarizing beam splitter and the vibrating body in the first optical path, and a second ¼ wave plate arranged between the polarizing beam splitter and the reflecting body in the second optical path, and the interferometer causes interference between a reflected beam reflected by the vibrating body and a reference beam reflected by the reflecting body to form a interference pattern. The detection means quantizes the vibration of the vibrating body on the basis of the formed interference pattern to detect the vibration.

In the vibration detection device according to the embodiment of the invention, the laser beam emitted from the light source is split into beams traveling along two optical paths (first and second optical paths) by the polarizing beam splitter included in the interferometer. At this time, in the first optical path (a reflection optical path), a reflected beam is reflected by a vibrating body via a first ¼ wave plate, and in the second optical path (a reference optical path), a reference beam is reflected by a reflecting body via a second ¼ wave plate, and the reflected beam and the reference beam interfere with each other to form an interference pattern. Then, on the basis of the interference pattern, the vibration of the vibrating body is quantized to be detected. Moreover, by such a configuration of the interferometer, the apparatus configuration is more compact, compared to that in a related art.

In the vibration detection device according to the embodiment of the invention, in the case where the polarization direction of the reflected beam and the polarization direction of the reference beam are orthogonal to each other, the above-described interferometer preferably includes first polarizing plates between the polarizing beam splitter and the detection means. In this case, the first polarizing plates have a polarizing axis in a direction inclined 45° from each of the polarization direction of the reflected beam and the polarization direction of the reference beam. In the case of such a configuration, interference between beams in the polarization directions orthogonal to each other can occur by the function of the first polarizing plates, thereby an interference pattern is formed.

In the vibration detection device according to the embodiment of the invention, the above-described detection means preferably includes four photoelectric conversion devices, a computation means, a figure producing means and a counter. In this case, the four photoelectric conversion devices each detect the interference pattern with a phase different by 90° from a phase of the interference pattern detected by the other photoelectric conversion device. Moreover, the computation means produces a pair of differential signals by obtaining a difference between output signals, from the four photoelectric conversion devices, with phases different by 180° from each other. Further, the figure producing means produces a lissajous figure with a circular or arc shape on a plane based on the pair of differential signals. The counter counts the number of times where a signal point defined by the pair of differential signals passes through a predetermined reference point on the produced lissajous figure. In such a configuration, the number of times where the signal point passes through on the lissajous figure is counted by the counter, so the displacement of variation of the vibrating body is quantized to be detected. Moreover, a pair of differential signals are produced from a difference between output signals, from four photoelectric conversion devices with phases different by 90° from one another, with phases different 180° from each other, and on the basis of the pair of differential signals, a lissajous figure is produced, so even in the case where a DC (direct current) offset component is produced in the output signal from the photoelectric conversion device, the DC offset component can be removed, thereby the displacement of the variation of the vibrating body can be stably detected.

In this case, it is more preferable that the above-described four photoelectric conversion devices are formed on a single substrate surface, and the above-described interferometer includes a beam splitting section, a third ¼ wave plate and four second polarizing plates. In this case, the above-described beam splitting section having four beam splitter arranged along a common optical path section in the first and second optical paths above the substrate surface, and the beam splitting section splits each of the reflected beam and the reference beam into four split beams, respectively, and allows the split beams to travel toward the photoelectric conversion devices. The above-described third ¼ wave plate is arranged between the beam splitting section and the substrate surface. The above-described second polarizing plates are arranged between the third ¼ wave plate and the substrate surface, and the second polarizing plates have polarizing axes oriented in directions different by 45° from one another. In such a configuration, above the substrate surface on which the four photoelectric conversion devices are formed, each of the reflected beam and the reference beam which travel along the common optical path section in the first and second optical path is split into four split beams, and the split beams are allowed to travel toward the photoelectric conversion devices (toward the substrate surface). The four split beams pass through the third ¼ wave plate to be changed to circular polarization, and then pass through the second polarization plate, so the polarization directions of the four split beams are different by 45° from one another, thereby in the four photoelectric conversion devices, the interference pattern is detected with a phase different by 90° from a phase of the interference pattern detected by the other photoelectric conversion device. Moreover, a laminate configuration in which the polarizing plate, the third ¼ wave plate and the beam splitting section are laminated in this order is formed above the substrate surface on which the photoelectric conversion devices are formed, so the configuration of the interferometer becomes compact, and the size of the apparatus is further reduced.

In the vibration detection device according to the embodiment of the invention, the laser beam from the light source is split into beams traveling along two optical paths (the first and second optical path) by the polarizing beam splitter, and the reflected beam reflected by the vibrating body via the first ¼ wave plate in the first optical path (the reflection optical path) and the reference beam reflected by the reflecting body via the second ¼ wave plate in the second optical path (the reference optical path) interfere with each other to form the interference pattern, and on the basis of the interference pattern, the vibration of the vibrating body is quantized to be detected, so by a more compact configuration than that in a related art, digital detection of the vibration of the vibrating body can be optically performed. Therefore, the size of the vibration detection device optically performing digital vibration detection can be reduced.

Other and further objects, features and advantages of the invention will appear more fully from the following description.

### BRIEF DESCRIPTION OF THE DRAWINGS

FIG. 1 is an illustration showing the whole configuration of a vibration detection device according to a first embodiment of the invention;

FIG. 2 is an illustration showing an example of a lissajous figure produced in a digital counting section shown in FIG. 1;

FIG. 3 is a plan view showing a configuration example in the case where the vibration detection device shown in FIG. 1 is arranged on a single substrate;

FIG. 4 is a sectional view showing a configuration example in the case where the vibration detection device shown in FIG. 1 is integrated on a semiconductor substrate;

FIG. 5 is an illustration showing the whole configuration of a vibration detection device according to a second embodiment of the invention;

FIG. 6 is a plan view showing a configuration example in the case where the vibration detection device shown in FIG. 5 is arranged on a single substrate;

FIG. 7 is a sectional view showing the configuration of a vibration detection device according to a third embodiment of the invention;

FIG. 8 is an illustration showing an example of a lissajous figure according to a modification of the invention; and

FIG. 9 is a block diagram showing a configuration example of an audio recording/reproduction system including a vibration detection device of the invention.

### DETAILED DESCRIPTION OF THE PREFERRED EMBODIMENTS

Preferred embodiments will be described in detail below referring to the accompanying drawings.

### First Embodiment

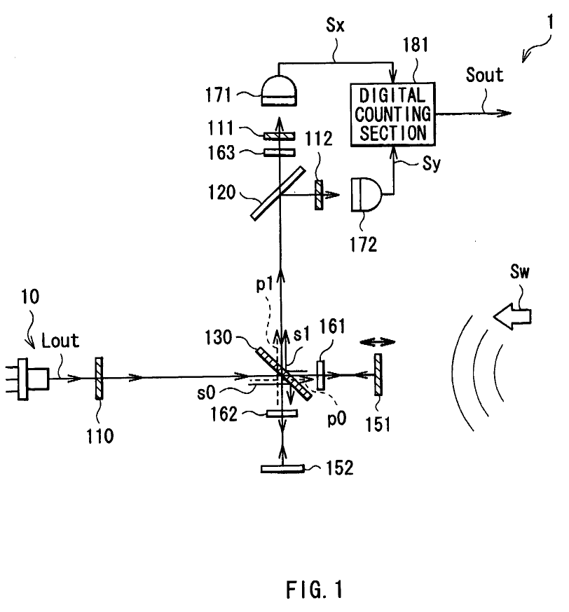

FIG. 1 shows the configuration of a vibration detection device (an optical microphone apparatus 1) according to a first embodiment of the invention. The microphone apparatus 1 outputs a binarized audio signal Sout through the use of a vibration film (a vibration film 151 which will be described later) in response to a sonic wave Sw, and includes a laser source 10, a polarizing plate 110, an interferometer with a configuration based on a Michelson interferometer including the vibration film 151, a reflecting plate (a reflecting plate 152 which will be described later), a polarizing beam splitter (a polarizing beam splitter 130 which will be described later) and two λ/4 plates (λ/4 plates 161 and 162 which will be described later) and a detection section outputting an output signal (the audio signal Sout) which is a digital signal.

The laser source 10 emits a laser beam Lout, and includes, for example, a multimode (Fabry-Perot type) laser source (such as, for example, an edge-emitting type semiconductor laser source), a single mode laser source (such as, for example, a surface-emitting type semiconductor laser source or a DFB (Distributed FeedBack) laser) or the like.

The polarizing plate 110 changes the direction of linear polarization of the laser beam Lout emitted from the laser source 10. More specifically, the polarizing axis of the polarizing plate 110 is oriented so that the direction of linear polarization of the laser beam Lout passing through the polarizing plate 110 is changed to be different by 45° from each of two polarizing axes of the polarizing beam splitter 130 which will be described later. In the case where the direction of linear polarization of the emitted laser beam Lout can be oriented in such a direction by rotating the laser source 10, the polarizing plate 110 is not necessarily arranged. However, in the case where the polarizing plate 110 is arranged as in the case of the embodiment, irrespective of the accuracy of the rotation position of the laser source 10, the direction of linear polarization of an incident beam to the polarizing beam splitter 130 can be oriented as described above.

### <Configuration of Interferometer>

The interferometer includes the polarizing beam splitter 130, the vibration film 151, the reflecting plate 152, three λ/4 plates 161 to 163, a beam splitter 120, and two polarizing plates 111 and 112.

The polarizing beam splitter 130 splits the laser beam Lout which is emitted from the laser source 10 and passes through the polarizing plate 110 into two components toward two optical paths, that is, a reflection optical path (a first optical path) to the vibration film 151 and a reference optical path (a second optical path) to the reflecting plate 152 to make the components travel along the optical paths. More specifically, although the details will be described later, the polarizing beam splitter 130 is designed to make a P-polarized component p0 of the laser beam Lout and an S-polarized component s0 of the laser beam Lout travel toward the reflection optical path and the reference optical path, respectively. As described above, the direction of linear polarization of the laser beam Lout entering the polarizing beam splitter 130 is oriented in a direction different by 45° from each of two polarizing axes (an S-polarizing axis and a P-polarizing axis) of the polarizing beam splitter 130, so the laser beam Lout entering the polarizing beam splitter 130 is split into the P-polarized component p0 and the S-polarized component s0 by approximately 50% each.

The vibration film 151 is displaced in response to the sonic wave Sw, and is made of, for example, the same vibration film with a gold evaporated surface or the like as that used in a condenser microphone. The vibration film 151 can reflect the laser beam Lout with a reflectivity of almost 100%. The reflecting plate 152 can reflect the laser beam Lout as a reference beam with a reflectivity of almost 100%.

The λ/4 plate 161 is arranged on an optical path between the polarizing beam splitter 130 and the vibration film 151, and the λ/4 plate 162 is arranged on an optical path between the polarizing beam splitter 130 and the reflecting plate 152.

The beam splitter 120 splits an S-polarized component s1 (a reflected beam) and a P-polarized component p1 (a reference beam) of the laser beam Lout, both of which enter the beam splitter 120 via the beam splitter 130, into approximately half of each of the S-polarized component s1 and the P-polarized component p1 to travel toward an optical path to the polarizing plate 111 and approximately half of each of the S-polarized component s1 and the P-polarized component p1 to travel toward an optical path to the polarizing plate 112.

The polarizing plates 111 and 112 each are a polarizing plate having a polarizing axis in a direction different by 45° from each of the polarization direction of the entering S-polarized component s1 (the reflected beam) and the polarization direction of the P-polarized component p1 (the reference beam). Although the details will be described later, by such a configuration, in the polarizing plates 111 and 112, the S-polarized component s1 and the P-polarized component p1 interfere with each other to form interference patterns. A λ/4 plate 163 is arranged on an optical path between the beam splitter 120 and the polarizing plate 111.

In the interferometer according to the embodiment, by such a configuration, the laser beam Lout emitted from the laser source 10 is split into two components toward two optical paths (the first optical path and the second optical path), and the components travel along the optical paths. More specifically, the laser beam Lout is split into a component toward the first optical path (a reflection optical path) passing through the polarizing beam splitter 130, the λ/4 plate 161, the vibration film 151, the λ/4 plate 161, the polarizing beam splitter 130, the beam splitter 120, the polarizing plates 111 and 112 and the λ/4 plate 163 and a component toward the second optical path (the reference optical path) passing through the polarizing beam splitter 130, the λ/4 plate 162, the reflecting plate 152, the λ/4 plate 162, the polarizing beam splitter 130, the beam splitter 120, the polarizing plates 111 and 112 and the λ/4 plate 163, and the components travel along the optical paths. At this time, a beam (the S-polarized component s1, the reflected beam) reflected by the vibration film 151 via the λ/4 plate 161 in the reflection optical path and a beam (the P-polarized component p1, the reference beam) reflected by the reflecting plate 152 via the λ/4 plat 162 in the reference optical path interfere with each other in the polarizing plates 111 and 112 to form interference patterns.

### <Configuration of Detection Section>

The detection section includes two photoelectric conversion devices 171 and 172 and the digital counting section 181.

The photoelectric conversion devices 171 and 172 detect the interference patterns formed on the polarizing plates 111 and 112, respectively, to perform photoelectric conversion on the interference patterns, and then the photoelectric conversion devices 171 and 172 output signals Sx and Sy, respectively. The photoelectric conversion devices 171 and 172 each include, for example, a PD (a Photo Diode) or the like.

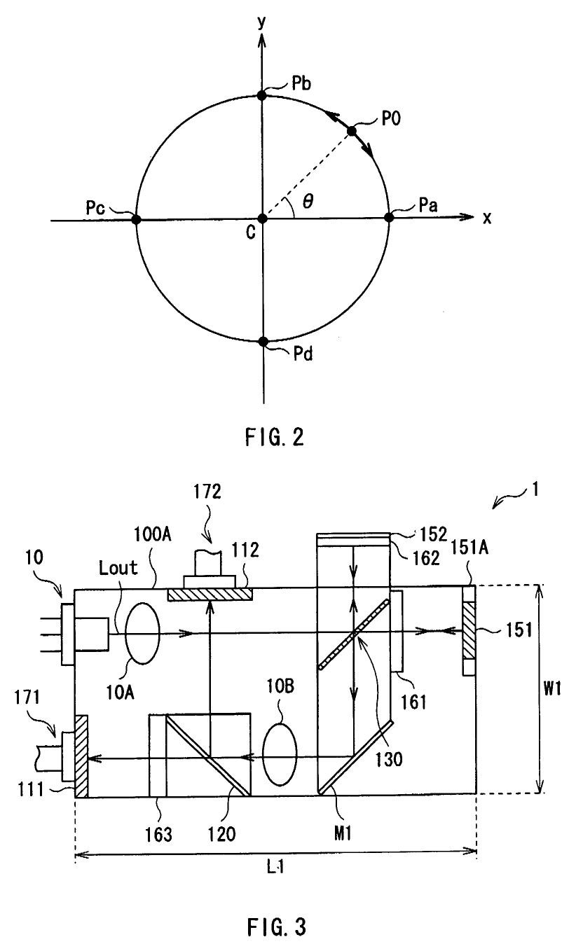

The digital counting section 181 counts the output signals Sx and Sy outputted from the photoelectric conversion devices 171 and 172, respectively, at predetermined counting intervals which will be described later through the use of, for example, a lissajous figure shown in FIG. 2 to quantize the output signals Sx and Sy, thereby the digital counting section 181 outputs an output signal (an audio signal Sout) which is a digital signal. A digital counting method using such a lissajous figure will be described in detail later.

Next, referring to FIG. 3, a configuration example in the case where the microphone apparatus 1 according to the embodiment is formed on a single substrate will be described below. FIG. 3 shows a plan view in the case where the microphone apparatus 1 shown in FIG. 1 is formed on a single substrate 100.

In the microphone apparatus 1 shown in FIG. 3, the laser source 10, a collimator lens 10A for condensing the laser beam Lout, the polarizing beam splitter 130, the vibration film 151, a support section 151A supporting the vibration film 151 from both sides, the reflecting plate 152, the polarizing plate 111 and 112, the beam splitter 120, a reflective mirror M1, the λ/4 plates 161 to 163 and the photoelectric conversion devices 171 and 172 are arranged on the a substrate (a substrate 100A) made of aluminum die-casting or the like. Among them, the polarizing beam splitter 130, the reflecting plate 152, the λ/4 plates 161 and 162 and the reflective mirror M1 are arranged to be bonded together into one unit, and the beam splitter 120 and the λ/4 plate 163 are arranged to be bonded together into one unit. In the microphone apparatus 1 shown in FIG. 3, the polarizing plate 110 is not arranged; however, the polarizing plate 110 may be arranged. When the microphone apparatus 1 is configured using a discrete optical member in such a manner, the microphone apparatus 1 shown in FIG. 3 has a small (compact) and firm configuration. The widths L1 and W1 (refer to FIG. 3) of the apparatus in this case can fall in, for example, L1=approximately 20 mm or less and W1=approximately 12 mm or less.

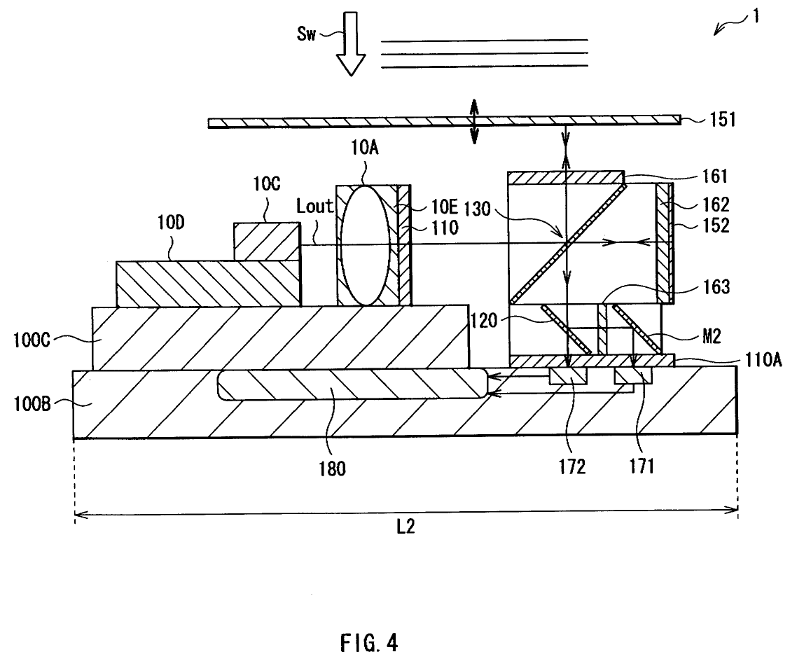

Next, referring to FIG. 4, a configuration example in the case where the microphone apparatus 1 according to the embodiment is integrated on a semiconductor substrate will be described below. FIG. 4 shows a sectional view in the case where the microphone apparatus shown in FIG. 1 is integrated on a Si (silicon) substrate 100B.

In the microphone apparatus 1 shown in FIG. 4, the photoelectric conversion devices 171 and 172 and a computation IC (Integrated Circuit) 180 functioning as the above-described digital counting section 181 are formed in the silicon (Si) substrate 100B, and an edge-emitting type laser source 10C as a laser source is formed on the a Si substrate 100C and a support section 10D formed in this order on the Si substrate 100B. Moreover, in front of the edge-emitting type laser source 10C, the collimator lens 10A for condensing the emitted laser beam Lout is supported by a support section 10E on the Si substrate 100C, and the collimator lens 10A, the support section 10E and the polarizing plate 110 are bonded together to be arranged as one unit. Further, on the photoelectric conversion devices 171 and 172, a combination of the polarizing plate 110A, the beam splitter 120, a reflective mirror M2 and the λ/4 plate 163, a combination of the polarizing beam splitter 130, the λ/4 plate 162 and the reflecting plate 152, and the λ/4 plate 161 are arranged in this order to be bonded together into one unit. Further, the vibration film 151 supported by a support section (not shown) is arranged above the edge-emitting type laser source 10C, the collimator lens 10A and the λ/4 plate 161. In the microphone apparatus 1 shown in FIG. 4, the polarizing plate 110 is not arranged; however, the polarizing plate 110 may be arranged. When the microphone apparatus 1 is integrated on a semiconductor substrate in such a manner, the microphone apparatus 1 shown in FIG. 4 has a smaller (more compact) configuration, compared to that shown in FIG. 3. The width L2 (refer to FIG. 4) of the apparatus in this case can fall in, for example, L2=approximately 5 mm or less (a width (not shown) in a depth direction of the sectional view) can be approximately 5 mm or less).

The vibration film 151 corresponds to a specific example of “a vibrating plate” in the invention, the reflecting plate 152 corresponds to a specific example of “a reflecting body” in the invention. The polarizing beam splitter 130 corresponds to a specific example of “a polarizing beam splitter” in the invention, and the λ/4 plate 161 corresponds to a specific example of “a first ¼ wave plate” in the invention, the λ/4 plate 162 corresponds to a specific example of “a second ¼ wave plate” in the invention. The photoelectric conversion devices 171 and 172 corresponds to a specific example of “a couple of photoelectric conversion devices” in the invention, and the photoelectric conversion devices 171 and 172 and the digital counting section 181 corresponds to specific examples of “a detection means” in the invention, and the digital counting section 181 corresponds to a specific example of “a figure producing means” and “a counter” in the invention. The polarizing plates 111 and 112 correspond to a specific example of “first polarizing plates” in the invention.

Next, referring to FIGS. 1 and 2, the operation of the microphone apparatus 1 according to the embodiment will be described in detail below.

In the microphone apparatus 1, as shown in FIG. 1, when the laser beam Lout is emitted from the laser source 10, and passes through the polarizing plate 110, the direction of linear polarization of the laser beam Lout is changed to a direction different by 45° from each of two polarizing axes (an S-polarizing axis and a P-polarizing axis) of the polarizing beam splitter 130.

Next, the laser beam Lout passing through the polarizing plate 110 is split into a component toward the reflection optical path (the first optical path) to the vibration film 151 and a component toward the reference optical path (the second optical path) to the reflecting plate 152 by the polarizing beam splitter 130 by 50% each, and they travel along the optical paths. Thereby, the laser beam Lout is split into the P-polarized component p0 traveling along the reflection optical path and the S-polarized component s0 (the reference beam) traveling along the reference optical path. In other words, in the polarizing beam splitter 130, a beam of an S-polarized component is reflected, and a beam of a P-polarized component passes through the polarizing beam splitter 130.

In this case, when the P-polarized component p0 passes through the λ/4 plate 161, the P-polarized component p0 is changed from linear polarization to circular polarization, and after that, when the P-polarized component p0 is reflected by the vibration film 151, the P-polarized component p0 is changed to reverse circular polarization, and passes through the λ/4 plate 161 again, thereby the P-polarized component p0 is converted into the S-polarized component s1 (the reflected beam). Then, the S-polarized component s1 is reflected by the polarizing beam splitter 130 as described above, so the S-polarized component s1 travels toward the beam splitter 120 on the reflection optical path. On the other hand, when the S-polarized component s0 as the reference beam passes through the λ/4 plate 162, the S-polarized component s0 is changed from linear polarization to circular polarization, and after that, when the S-polarized component s0 is reflected by the reflecting plate 152, the S-polarized component s0 is changed to reverse circular polarization, and passes through the λ/4 plate 162 again, thereby the S-polarized component s0 is converted into the P-polarized component p1. Then, the P-polarized component p1 passes through the polarizing beam splitter 130 as described above, so the P-polarized component p1 travels toward the beam splitter 120 on the reference optical path. At this time, the S-polarized component s1 and the P-polarized component p1 which travel along the same optical paths (the reflection optical path and the reference optical path) have polarization directions different by 90° from each other, so they do not interfere with each other.

Next, the S-polarized component s1 and the P-polarized component p1 which travel along the reflection optical path and the reference optical path are split into approximately 50% of each of the S-polarized component s1 and the P-polarized component p1 toward an optical path to the polarizing plate 111 and approximately 50% of each of the S-polarized component s1 and the P-polarized component p1 toward an optical path to the polarizing plate 112, and they travel along the optical paths to reach the polarizing plates 111 and 112. At this time, the λ/4 plate 163 is inserted in the middle of the optical path to the polarizing plate 111, so the S-polarized component s1 and the P-polarized component p1 which reach the vibrating plate 111 and the S-polarized component s1 and the P-polarized component p1 which reach the vibrating plate 112 have phases different by 90° from each other. The polarizing plates 111 and 112 each have a polarizing axis in a direction inclined 45° from each of the polarization direction of the S-polarized component s1 and the polarization direction of the P-polarized component p1, so in the embodiment in which the phases of the S-polarized component s1 and the P-polarized component p1 are different by 90° from each other, the S-polarized component s1 and the P-polarized component p1 of the reference beam interfere with each other in the polarizing plates 111 and 112 to form the interference patterns.

Next, the interference patterns formed on the polarizing plates 111 and 112 are detected by the photoelectric conversion devices 171 and 172, respectively. In this case, as described above, the S-polarized component s1 and the P-polarized component p1 which reach the vibrating plate 111 and the S-polarized component s1 and the P-polarized component p1 which reach the vibrating plate 112 have phases different by 90° from each other, so in the photoelectric conversion devices 171 and 172, the interference patterns are detected in a state in which the phases thereof are different by 90° from each other. Then, the interference pattern detected by the photoelectric conversion device 171 is converted into an electrical signal, and the electrical signal is outputted as the output signal Sx, and on the other hand, the interference pattern detected by the photoelectric conversion device 172 is converted into an electrical signal, and the electrical signal is outputted as the output signal Sy.

Next, in the digital counting section 181, the output signals Sx and Sy from the photoelectric conversion devices 171 and 172 are considered as an X signal and a Y signal, respectively, and, for example, a lissajous figure with a circular or arc shape shown in FIG. 2 is produced. More specifically, at first, the median value of the strength of the interference pattern by a (X, Y) signal is defined as a central point C (CX, CY), and the computation of the following formulas (1) and (2) is performed to convert the (X, Y) signal to a (x, y) signal.

x=X−CX (1)

y=Y−CY (2)

Then, by the computation of the above-described formulas (1) and (2), from the movement of the signal point (x, y), as shown in FIG. 2, a lissajous figure in which the signal point (x, y) rotates on the circumference of a circle around the central point C can be obtained. At this time, a detection point (for example, a signal point P0 in the drawing) detected by the photoelectric conversion devices 171 and 172 is one point on the circumference of the circle, and the detection point is displaced on the circumference of the circle according to the displacement of the vibration film 151. Therefore, when the number of times where such a signal point P0 passes through a predetermined reference point (for example, four reference points Pa to Pd on an x axis and a y axis) is counted, the strength of the interference pattern is uniquely determined, so the displacement of the vibration film 151 is digitally detected, and the counted number is outputted as an audio signal Sout which is a digital signal as information of an angle α. In the case where the number of times where the signal point P0 passes through four reference points Pa to Pd as reference points is counted in such a manner, it means that the number of times where the interference patterns are shifted by 90° (¼ wavelength) is counted.

As described above, in the embodiment, the laser beam Lout from the laser source 10 is split into components toward two optical paths (the first optical path and the second optical path) by the polarizing beam splitter 130, and the components travel along the optical paths, and while the S-polarized component s1 (the reflected beam) reflected by the vibration film 151 in the first optical path (the reflection optical path) via the λ/4 plate 161 and the P-polarized component p1 (the reference beam) reflected by the reflecting plate 152 via the λ/4 plate 162 in the second optical path (the reference optical path) interfere with each other to form interference patterns, and on the basis of the interference patterns, the vibration of the vibration film 151 is quantized to be detected, so optical digital detection of vibration of the vibration film 151 can be performed by a more compact configuration than that in a related art. More specifically, the interferometer with a configuration based on the Michelson interferometer is used as the interferometer, so the microphone apparatus with a small and simple configuration can be achieved. Therefore, in the vibration detection device (the microphone apparatus) optically performing digital vibration detection, the size of the apparatus can be reduced.

Moreover, the interferometer is configured using the polarizing beam splitter 130 and the λ/4 plates 161 and 162, so the reverse of the laser beam Lout to the laser source 10 which occurs in a pure Michelson interferometer can be prevented, and noise generation in the laser source 10 can be prevented. Therefore, compared to the case where the interferometer is configured using a pure Michelson interferometer, a better S/N ratio can be obtained, the detection accuracy of vibration of the vibration film 151 can be improved.

Moreover, the interference patterns are detected with two photoelectric conversion devices 171 and 172, and a phase difference between the interference patterns detected by the photoelectric conversion devices 171 and 172 is designed to be approximately 90°, so a circular lissajous figure can be formed as below, and detection can be easily performed.

Further, the output signals Sx and Sy from two photoelectric conversion devices 171 and 172 are converted into the X signal and the Y signal, respectively, and a lissajous figure with a circular or arc shape on the basis of the X and Y signals is produced, so the detected point of the interference pattern is displaced on the circumference of a circuit according to displacement of the vibration film 151, and the number of times where the detected point passes through a predetermined reference point is counted, thereby digital detection of the displacement of the vibration film 151 can be performed.

### Second Embodiment

Next, a second embodiment of the invention will be described below. Like components are denoted by like numerals as of the first embodiment and will not be further explained.

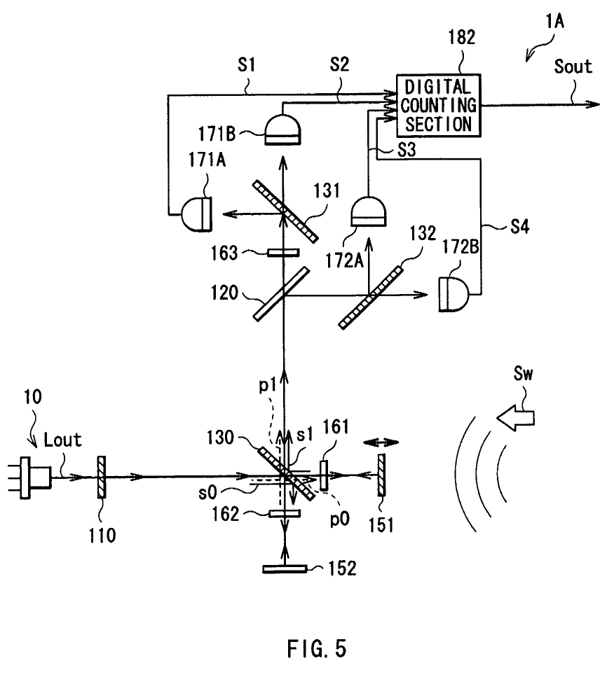

FIG. 5 shows the configuration of a vibration detection device (a microphone apparatus 1A) according to the embodiment. The microphone apparatus 1A includes polarizing beam splitters 131 and 132 instead of the polarizing plates 111 and 112 in the microphone apparatus 1 according to the first embodiment shown in FIG. 1, and includes two pairs of photoelectric conversion devices (photoelectric conversion devices 171A, 171B, 172A and 172B) instead of the photoelectric conversion devices 171 and 172, and a digital counting section 182 instead of the digital counting section 181.

The polarizing beam splitter 131 splits the reached S-polarized component s1 and the reached P-polarized component p1 to provide them to the photoelectric conversion devices 171A and 171B. Moreover, the polarizing beam splitter 132 splits the reached S-polarized component s1 and the reached P-polarized component p1 to provide them to the photoelectric conversion devices 172A and 172B. In such a configuration, in the photoelectric conversion devices 171A, 171B, 172A and 172B, the interference patterns are detected in a state in which the phases thereof are different by 90° from each other, and four output signals S1 to S4 with phases different by 90° from one another can be obtained. In this case, the signal values I(S1) to I(S4) of the output signals S1 to S4 are represented by, for example, the following formulas (3) to (6). In addition, A and B represent the amplitudes of interfering beams, and λ represents the wavelength of the laser beam Lout, ΔL represents an optical path difference between the reference optical path and the reflection optical path.

I(S1)=(A²+B²)+2AB×sin (2πΔL/λ) (3)

I(S2)=(A²+B²)−2AB×sin (2πΔL/λ) (4)

I(S3)=(A²+B²)+2AB×cos (2πΔL/λ) (5)

I(S4)=(A²+B²)−2AB×cos (2πΔL/λ) (6)

In addition to the functions in the digital counting section 181 described in the first embodiment, the digital counting section 182 produces a pair of differential signals SA and SB (I(SA)=I(S1)−I(S2) and I(SB)=I(S3)−I(S4)) by obtaining a difference between output signals with phases different by 180° from each other (between the output signals S1 and S2 and between the output signals S3 and S4) among four output signals S1 to S4 obtained by the photoelectric conversion devices 171A, 171B, 172A and 172B. Moreover, the digital counting section 182 produces a lissajous figure based on a set of first differential signals SA and SB is considered as a signal point.

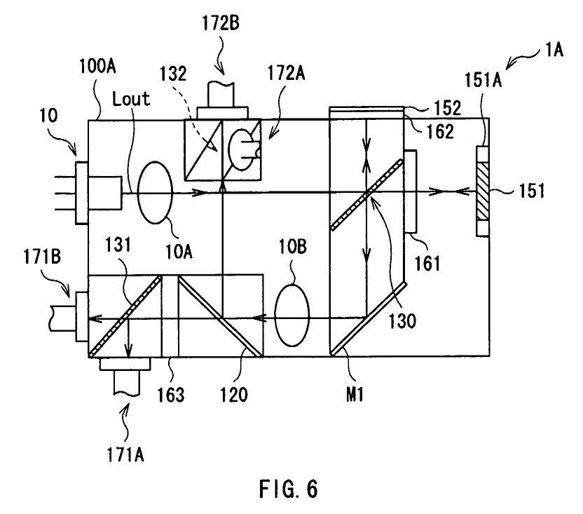

In the case where the microphone apparatus 1A according to the embodiment is formed on the substrate 100A using a discrete optical member, as in the case of the first embodiment, for example, the microphone apparatus 1A can be configured as shown in FIG. 6.

The photoelectric conversion devices 171A, 171B, 172A and 172B correspond to a specific example of “four photoelectric conversion devices” in the invention. The photoelectric conversion devices 171A, 171B, 172A and 172B and the digital counting section 182 correspond to specific examples of “a detection means” in the invention, and the digital counting section 182 corresponds to a specific example of “a computation means”, “a figure producing means” and “a counter” in the invention.

By such a configuration, in the microphone apparatus 1A according to the embodiment, a pair of differential signals SA and SB are produced from a difference between output signals, with phases different by 180° from each other among four output signals S1 to S4 from four photoelectric conversion devices 171A, 171B, 172A and 172B with phases different by 90° from one another, and on the basis of the pair of differential signals SA and SB, a lissajous figure is produced, so even in the case where a DC (direct current) offset component (for example, a portion of (A²+B²) in the above-described formulas (3) to (6)) due to strength fluctuations of the laser beam Lout is produced in the output signal from the photoelectric conversion device, the DC offset component can be cancelled and removed. Therefore, in addition to the effects in the first embodiment, the vibration of the vibration film 151 can be detected more stably, and the detection accuracy can be further improved.

### Third Embodiment

Next, a third embodiment of the invention will be described below. Like components are denoted by like numerals as of the first and second embodiment and will not be further explained.

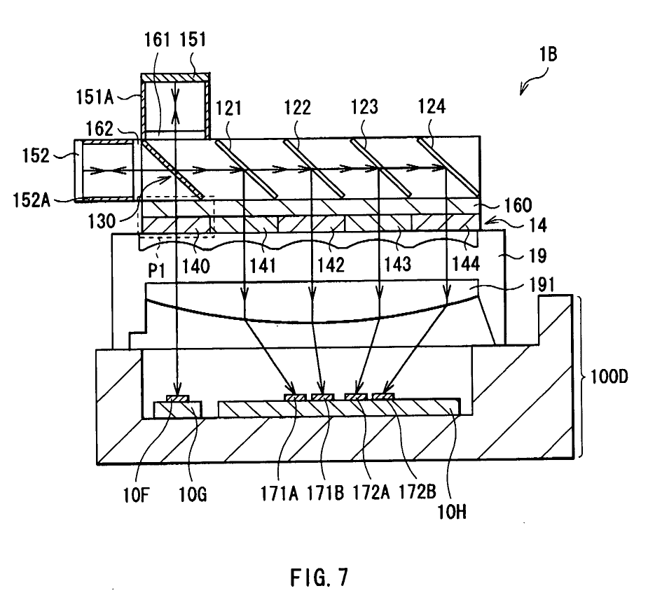

FIG. 7 shows a sectional view of a vibration detection device (a microphone apparatus 1B) according to the embodiment. The microphone apparatus 1B corresponds to a modification of the microphone apparatus 1A according to the second embodiment shown in FIG. 5, and a laser source (a surface-emitting type laser source 10F which will be described later) and four photoelectric conversion devices (the photoelectric conversion devices 171A, 171B, 172A and 172B) are formed on semiconductor substrates (Si substrates 10G and 10H which will be described later, respectively), and the interferometer is formed on a containing member (a containing member 100D which will be described later), more specifically above the laser source and the photoelectric conversion devices.

The containing member 100D contains the Si substrates 10G and 10H, the surface-emitting type laser source 10F and the photoelectric conversion devices 171A, 171B, 172A and 172B, and supports the interferometer including a lens section 19 which will be described later. The containing member 100D is made of, for example, a material such as ceramic.

The surface-emitting type laser source 10F is a so-called vertical cavity surface emitting laser (VCSEL) type laser source, and is of a single mode. The lens section 19 including a collimator lens 191 is arranged above the surface-emitting type laser source 10F.

The above-described interferometer includes the polarizing beam splitter 130, the vibration film 151, the reflecting plate 152, four beam splitters 121 to 124, three λ/4 plates 160 to 162, a polarizing plate 14 and the lens section 19.

The polarizing beam splitter 130 splits the laser beam Lout which is emitted from the laser source 10 and passes through the polarizing plate 14 (more specifically, a polarizing plate 140 which will be described later) and the λ/4 plate 160 into components toward two optical paths, that is, a reflection optical path (a first optical path) to the vibration film 151 and a reference optical path (a second optical path) to the reflecting plate 152 to make the components travel along the optical paths. More specifically, in the polarizing beam splitter 130, a P-polarized component of the laser beam is set to travel toward the reflection optical path, and an S-polarized component of the laser beam is set to travel toward the reference optical path. In this case, the polarizing axis of the polarizing plate 140 is oriented in a direction different by 45° from each of polarizing directions of the P-polarized component and the S-polarized component, thereby the incident laser beam Lout is split into the P-polarized component and the S-polarized component by approximately 50% each.

The λ/4 plate 161 is arranged above the polarizing beam splitter 130, and the λ/4 plate 162 is arranged on a side of the polarizing beam splitter 130 (on the left in FIG. 7). The vibration film 151 is supported by a support section 151A above the λ/4 plate 161, and the reflecting plate 152 is supported by a support section 152A on a side of the λ/4 plate 162 (on the left in FIG. 7).

The beam splitters 121 to 124 are arranged on a side of the polarizing beam splitter 130 (on the right in FIG. 7) above the photoelectric conversion devices 171A, 171B, 172A and 172B (in other words, a substrate surface of the Si substrate 10H), respectively. More specifically, the beam splitters 121 to 124 are located in this order along a common optical path section (an optical path section from the polarizing beam splitter 130 to the beam splitter 121 to 124) both in the reflection optical path (the first optical path) for a reflected beam reflected by the vibration film 151 and the polarizing beam splitter 130 and in the reference optical path (the second optical path) for a reference beam reflected by the reflecting plate 152 to pass through the polarizing beam splitter 130. The beam splitters 121 to 124 are set so that the transmittance of an incident beam is approximately ¾, approximately ⅔, approximately ½ and approximately 0 (in other words, the reflectivity of the incident beam is approximately ¼, approximately ⅓, approximately ½ and approximately 1), respectively, thereby while each of the reflected beam and the reference beam traveling along the above-described optical path section are split into four split beams L1 to L4, the split beams L1 to L4 are allowed to travel toward the photoelectric conversion devices 171A, 171B, 172A and 172B, respectively.

The λ/4 plate 160 is arranged between the beam splitters 121 to 124 and the polarizing plate 14, and four split beams L1 to L4 entering the λ/4 plate 160 are changed from linear polarization to circular polarization.

The polarizing plate 14 is arranged between the λ/4 plate 160 and the lens section 19, and includes the polarizing plate 140 into which the laser beam Lout emitted from the surface-emitting type laser source 10F enters, and four polarizing plates 141 to 144 into which the split beams L1 to L4 enter, respectively. Moreover, the polarizing plates 140 to 144 are arranged in this order along a horizontal direction. Among them, the polarizing axes of the polarizing plates 141 to 144 are oriented in directions different by 45° from one another. More specifically, the polarizing axes of the polarizing plates 141 to 144 are oriented, for example, at 45°, 90°, 135° and 180°, respectively.

The lens section 190 includes the collimator lens 191. The collimator lens 191 condenses the split beams L1 to L4, and then allows the split beams L1 to L4 to enter the photoelectric conversion devices 171A, 171B, 172A and 172B, respectively.

The beam splitters 121 to 124 correspond to specific examples of “a beam splitting section” in the invention, and the λ/4 plate 160 corresponds to a specific example of “a third ¼ wave plate” in the invention, and the polarizing plate 14 corresponds to a specific example of “four second polarizing plates” in the invention.

In the microphone apparatus 1B according to the embodiment, by such a configuration, above a substrate surface (the substrate surface of the Si substrate 10H) on which four photoelectric conversion devices 171A, 171B, 172A and 172B are formed, each of the reflected beam and the reference beam traveling along the common optical path section in the reflection optical path and the reference optical path are split into four split beams L1 to L4 by the beam splitters 121 to 124, and the split beams L1 to L4 are allowed to travel toward the photoelectric conversion devices 171A, 171B, 172A and 172B (toward the substrate surface). Then, after the four split beams L1 to L4 pass through the λ/4 plate 160 to be changed to circular polarization, when the split beams L1 to L4 pass through the polarizing plates 141 to 144, the polarization direction of the split beams L1 to L4 are changed to be different by 45° from one another, thereby in the four photoelectric conversion devices 171A, 171B, 172A and 172B, the interference patterns are detected in a state in which the phases thereof are different by 90° from each other. Therefore, the same effects as those in the first and second embodiment can be obtained. In other words, in the vibration detection device (the microphone apparatus) optically performing digital vibration detection, the size of the apparatus can be reduced.

Moreover, a laminate configuration in which the polarizing plate 14, the λ/4 plate 160 and the beam splitters 121 to 124 are laminated in this order is formed above the substrate surface of the Si substrate 10H on which the photoelectric conversion devices 171A, 171B, 172A and 172B are formed, so the configuration of the interferometer is compact. Therefore, compared to the microphone apparatus 1A described in the second embodiment, the size of the apparatus can be further reduced.

In the microphone apparatus 1B shown in FIG. 7, the case where the polarizing plate 14 (more specifically the polarizing plate 140) and the λ/4 plate 160 are arranged above the surface-emitting type laser source 10F to adjust the direction of linear polarization of the laser beam Lout entering the polarizing beam splitter 130 is described, however, if the direction of linear polarization of the emitted laser beam Lout can be oriented in such a direction by rotating the surface-emitting type laser source 10F, a portion indicated by a reference symbol P1 (the polarizing plate 140 and a part of the λ/4 plate 160) in FIG. 7 in the polarizing plate 14 and the λ/4 plate 160 may not be arranged. In the case where the portion is not arranged, the light loss of the laser beam Lout by the portion indicated by the reference symbol P1 is prevented, so optical output can be improved, and the detection accuracy of vibration of the vibration film 151 can be improved. On the other hand, in the case of the configuration shown in FIG. 7, irrespective of the accuracy of the rotation position of the laser source 10, the direction of linear polarization of an incident beam to the polarizing beam splitter 130 can be oriented as described above.

Moreover, a pinhole may be arranged on each of the photoelectric conversion devices 171A, 171B, 172A and 172B to finely adjust the phase of an interference pattern to be detected. In the case of such a configuration, the S/N ratio in the output signals S1 to S4 from the photoelectric conversion devices can be improved, and the detection accuracy of vibration of the vibration film 151 can be further improved.

Although the present invention is described referring to the first, second and third embodiments, the invention is not limited to them, and can be variously modified.

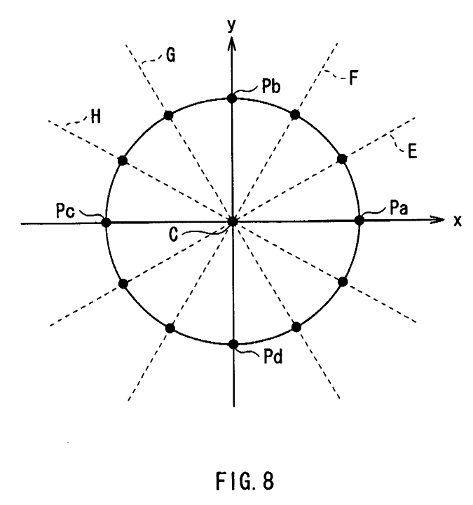

For example, in the above-described embodiments, the case where four reference points Pa to Pd are arranged on the lissajous figure to perform digital counting is described; however, the number of reference points is not limited to four, and, for example, as shown in FIG. 8, for example, reference lines E to H may be used in addition to four reference points Pa to Pd to arrange more reference points with a smaller spacing. In such a configuration, the counting number can be increased, so the value of the output signal Sout can be increased, and the detection sensitivity can be further improved.

Moreover, in the above-described embodiments, the case where a semiconductor laser is used as the light source emitting the laser beam Lout is described; however, except for the semiconductor laser, for example, a gas laser, a solid-state laser or the like may be used.

Further, in the above-described embodiments, as an example of the vibration detection device according to the embodiments of the invention, the optical microphone apparatus in which the vibrating body is the vibration film (the vibration film 151) vibrating in response to a sonic wave, and the vibration of the vibration film 151 are detected as the audio signal Sout is described; however, the vibration detection device according to the embodiments of the invention is not limited to this, and may be configured to detect other vibration.

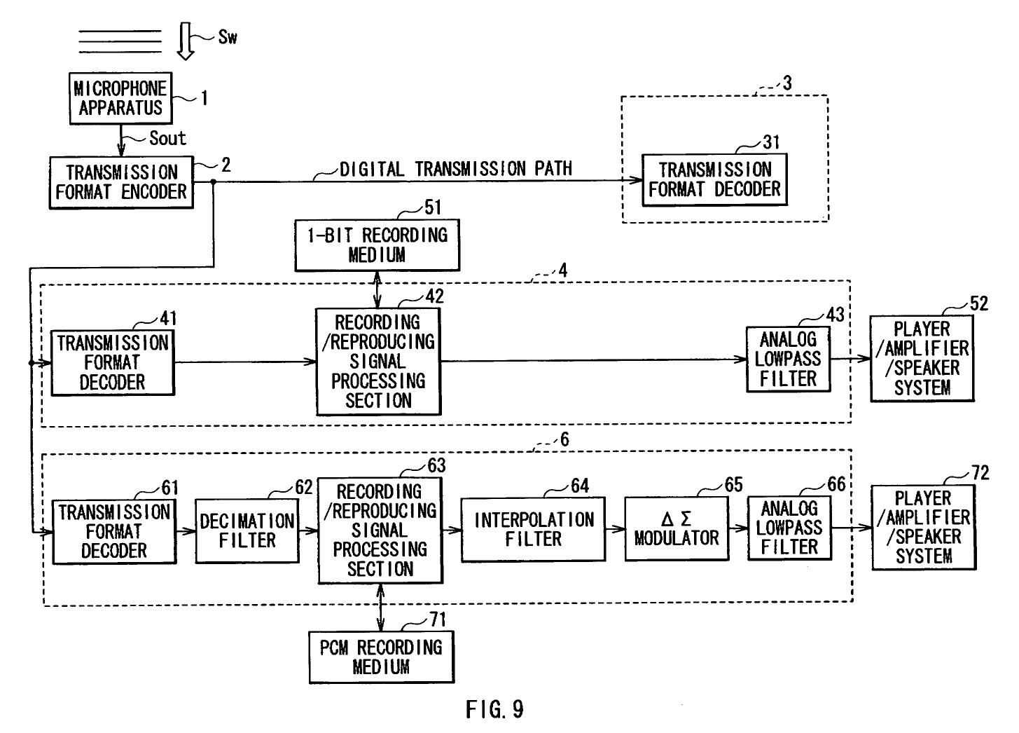

For example, as shown in FIG. 9, the vibration detection device (the microphone apparatus) according to the embodiments of the invention can be applied to an audio signal recording/reproducing system including, in addition to the microphone apparatus 1 shown in FIG. 1 (or the microphone apparatus 1A shown in FIG. 5, the microphone apparatus 1B shown in FIG. 7 or the like), a transmission format encoder 2 which encodes the audio signal Sout outputted from the microphone apparatus 1, an editing device 3 connected with the transmission format encoder 2 by a digital transmission path (for example, an optical fiber or the like), a 1-bit stream recorder 4, a PCM (Pulse Code Modulation) recorder 6, a 1-bit recording medium 51, a PCM recording medium 71, and player/amplifier/speaker systems 52 and 72. The editing device 3 includes a transmission format decoder 31. The 1-bit stream recorder 4 includes a transmission format decoder 41 connected to the transmission format encoder 2 via a digital transmission path, a recording/reproducing signal processing section 42 connected to the transmission format decoder 41 and the 1-bit recording medium 51, and an analog lowpass filter 43 connected between the recording/reproducing signal processing section 42 and the player/amplifier/speaker system 52. The PCM recorder 6 includes a transmission format decoder 61 connected to the transmission format encoder 2 via a digital transmission path, a decimation filter 62 connected to the transmission format decoder 61, a recording/reproducing signal processing section 63 connected to the decimation filter 62 and the PCM recording medium 71, an interpolation filter 64 connected to the recording/reproducing signal processing section 63, a ΔΣ modulator 65 connected to the interpolation filter 64, and an analog lowpass filter 66 connected between the ΔΣ modulator 65 and the player/amplifier/speaker system 72. In the audio signal recording/reproducing system with such a configuration, a binarized audio signal Sout can be transmitted, so compared to the case where an analog audio signal is transmitted, long-distance transmission can be easily performed.

It should be understood by those skilled in the art that various modifications, combinations, sub-combinations and alterations may occur depending on design requirements and other factors insofar as they are within the scope of the appended claims or the equivalents thereof.

What is claimed is:

1. A vibration detection device comprising:
a light source emitting a laser beam;
an interferometer including a vibrating body and a reflecting body both capable of reflecting the laser beam, a polarizing beam splitter splitting a laser beam emitted from the light source into beams traveling along first and second optical paths, a first ¼ wave plate arranged between the polarizing beam splitter and the vibrating body in the first optical path, and a second ¼ wave plate arranged between the polarizing beam splitter and the reflecting body in the second optical path, the interferometer causing interference between a reflected beam reflected by the vibrating body and a reference beam reflected by the reflecting body to form a interference pattern; and
a detection means quantizing the vibration of the vibrating body on the basis of the formed interference pattern to detect the vibration.

2. The vibration detection device according to claim 1, wherein
the polarization direction of the reflected beam and the polarization direction of the reference beam are orthogonal to each other, and
the interferometer includes first polarizing plates between the polarizing beam splitter and the detection means, the first polarizing plates having a polarizing axis in a direction inclined 45° from each of the polarization direction of the reflected beam and the polarization direction of the reference beam.

3. The vibration detection device according to claim 1, wherein the detection means includes:
a couple of photoelectric conversion devices each detecting the interference pattern with a phase different by 90° from a phase of the interference pattern detected by another photoelectric conversion device,
a figure producing means producing a lissajous figure with a circular or arc shape on a plane based on a pair of output signals from the photoelectric conversion devices, and
a counter counting the number of times where a signal point defined by the pair of output signals passes through a predetermined reference point on the produced lissajous figure.

4. The vibration detection device according to claim 1, wherein the detection means includes:
four photoelectric conversion devices each detecting the interference pattern with a phase different by 90° from a phase of the interference pattern detected by the other photoelectric conversion device,
a computation means producing a pair of differential signals by obtaining a difference between output signals, from the four photoelectric conversion devices, with phases different by 180° from each other,
a figure producing means producing a lissajous figure with a circular or arc shape on a plane based on the pair of differential signals, and
a counter counting the numbers of times where a signal point defined by the pair of differential signals passes through a predetermined reference point on the produced lissajous figure.

5. The vibration detection device according to claim 4, wherein
the four photoelectric conversion devices are formed on a single substrate surface,
the interferometer includes:
a beam splitting section having four beam splitter arranged along a common optical path section in the first and second optical paths above the substrate surface, the beam splitting section splitting each of the reflected beam and the reference beam into four split beams, respectively, and allowing the split beams to travel toward the photoelectric conversion devices,
a third ¼ wave plate arranged between an extending surface of the beam splitting section and the substrate surface, and
four second polarizing plates arranged between the third ¼ wave plate and the substrate surface, the second polarizing plates having polarizing axes oriented in directions different by 45° from one another.

6. The vibration detection device according to claim 1, wherein
the light source, the interferometer and the detection means are integrated on a semiconductor substrate.

7. The vibration detection device according to claim 1, wherein
the light source, the interferometer and the detection means are formed on a single substrate.

8. The vibration detection device according to claim 1, wherein
the vibrating body is a vibration film vibrating in response to a sonic wave, and the vibration detection device is configured as an optical microphone apparatus detecting the vibration of the vibration film as a quantized audio signal.

9. A vibration detection device comprising:
a light source emitting a laser beam;
an interferometer including a vibrating body and a reflecting body both capable of reflecting the laser beam, a polarizing beam splitter splitting a laser beam emitted from the light source into beams traveling along first and second optical paths, a first ¼ wave plate arranged between the polarizing beam splitter and the vibrating body in the first optical path, and a second ¼ wave plate arranged between the polarizing beam splitter and the reflecting body in the second optical path, the interferometer causing interference between a reflected beam reflected by the vibrating body and a reference beam reflected by the reflecting body to form a interference pattern; and
a detection section quantizing the vibration of the vibrating body on the basis of the formed interference pattern to detect the vibration.
